(19) United States
(12) Patent Application Publication
(10) Pub. No.: US 2002/0008138 A1
(43) Pub. Date: Jan. 24, 2002

(54) Sheet processing apparatus and method for close examining sheets in the same, and transaction apparatus

(76) Inventors: Sadaji Yamauchi, Kyoto (JP); Kinya Toda, Kyoto (JP); Ryoichi Saiki, Kyoto (JP); Akira Maeda, Kyoto (JP)

Correspondence Address: Thomas J. D'Amico, DICKSTEIN SHAPIRO MORIN & OSHINSKY LLP, 2101 L Street NW, Washington, DC, 20037-1526, US

(21) Appl. No.: 09/832,855

(22) Filed: Apr. 12, 2001

(30) Foreign Application Priority Data
Apr. 13, 2000 (JP) P. 2000-112015

(51) Int. Cl. G06F 17/60; B65H 7/12

(52) U.S. Cl. 235/379; 271/262

(57) ABSTRACT

A sheet processing apparatus comprises a plurality of sheet storage sections; a count section; and a storage section. The sheet storage sections allow sheets to be entered in and taken from via a transport passage. The count section counts the number of sheets transported in an improper transport state of skew transport, overlap transport, etc., in addition to a normal transport state when sheets are normally transported. The storage section stores the count for storing and managing the number of sheets transported.

### BACKGROUND OF THE INVENTION

1. Field of the Invention

This invention relates to a sheet processing apparatus and a method for close examining sheets in the sheet processing apparatus applied to an automatic telling machine (ATM), an automatic ticket dispenser, etc., for example, and more particularly to a sheet processing apparatus for precisely grasping and managing the current balance of sheets such as bills, exchange tickets, book coupons, or checks in the apparatus and a transaction apparatus comprising the sheet processing apparatus.

2. Description of the Related Art

In the description to follow, a sheet processing apparatus contained in an ATM is taken as an example. Normally, this kind of sheet processing apparatus allows paying-in and paying-out transactions. For example, to conduct apaying-out transaction, specified bills are paid out one by one from first to third by-denomination stackers 101, 102, and 103 in the apparatus until the number of paid-out bills reaches the number of transaction bills, as shown in FIG. 10. The paid-out bills pass through a validation section 104 to count the number of the bills, then the bills are discharged to a paying-in/paying-out slot 105.

At this time, bills transported in an overlap state because of a bill separation failure, skewed bills, folded or broken bills, etc., cannot be checked for validity and are collected in a collection cartridge 106 as rejected bills that cannot be counted. Thus, the number of the rejected bills collected in the collection cartridge 106 is unknown.

To eliminate such an uncertain element, i.e., to count the number of the rejected bills, close examination processing for periodically counting and managing the current balance of bills is performed under present circumstances. As shown in FIG. 11, in the close examination processing, the bills are transferred one by one from one by-denomination stacker 101 . . . , to an operation cartridge 107 and the number of bills passing through the validation section 104 is counted in the transport process. After the counting is complete, the bills are restored one by one to the former stacker from the operation cartridge 107. The close examination processing is performed in order for each stacker.

However, when the close examination processing is performed, operation of the ATM must be interrupted for a given time. Consequently the availability factor is lowered and transaction use of the ATM is stopped, degrading serviceability for customers. Further, at the close examination processing time, a large number of bills stored for each stacker are transferred between each stacker and the operation cartridge 107, inducing occurrence of a paper jam. To count the number of the rejected bills collected in the collection cartridge 106, as shown in FIG. 12, an official in charge takes out the collection cartridge 106 to the outside of the apparatus and manually counts the number of the rejected bills and thus the work requires time and labor; transaction cannot be restarted unless the collected bill amount in the collection cartridge is checked to precisely grasp the current balance.

Using two collection cartridges together is also possible; for example, the rejected bills occurring in paying-out transaction before close examination are collected in one collection cartridge and the rejected bills occurring in paying-out transaction after the close examination are collected in the other for sorting, whereby the current balance can be determined accurately.

In this case, however, the official in charge must also manually count the number of the rejected bills in the collection cartridge for each close examination processing and the work requires time and labor; operation of the ATM must be stopped for a long time and the close examination processing cannot fully be automated.

Thus, as a measure to handle rejected bills, Japanese Patent Unexamined Publication No. Hei. 5-46842 discloses a rejected bill sense mechanism which is disposed in a transport passage. In the rejected bill sense mechanism, the pattern of each passing-through bill is extracted from the sense data, and the number-of-bills check data is provided for enhancing the counting performance.

In this case, however, the number of skewed bills, folded or broken bills, etc., other than bills transported in an overlap state cannot be counted and the current balance cannot automatically be managed; this is a problem.

### SUMMARY OF THE INVENTION

It is therefore an object of the invention to provide a sheet processing apparatus and a method for close examining sheets in the sheet processing apparatus wherein if various rejected sheets are caused by an improper transport state of overlap transport or skew transport and an improper sheet state of fold, break, lack, etc. , of the sheets themselves, the number of sheets are counted precisely one by one before the sheets are entered in a collection box and the total number of sheets held in the apparatus is counted and managed under full automation, and a transaction apparatus comprising the sheet processing apparatus.

In the invention, a sheet processing apparatus comprises a plurality of sheet storage sections for allowing sheets to be entered in and taken from via a transport passage; a count section for counting the number of sheets transported in an improper transport state of overlap transport, skew transport, etc., and an improper sheet state of fold, break, etc., in addition to a normal transport state when sheets are normally transported; a judgment section for determining whether or not the count section counts correctly; and a storage section for storing the count value for storing and managing the number of sheets transported if it is determined that the count section counts correctly.

Thus, when sheets are transported, even if an improper transport state of overlap transport, skew transport, etc., occurs or an improper sheet of fold, break, etc., is transported, the sheet can be transported in the improper state and be counted. Therefore, the total number of sheets held in the sheet processing apparatus can always be precisely counted and managed regardless of the transport state of sheets or the state of each sheet itself.

For example, if the sheet processing apparatus is contained in an ATM, although overlap transport, skew transport, fold, or break occurs, the passing-through bills can be precisely counted one by one, so that the count value is stored. Accordingly, at the close examination time, a close examination can be instantaneously conducted simply by reading the count value without transporting any bills. Thus, the total number of sheets held in the sheet processing apparatus can be counted and managed under full automation.

Consequently, close examination processing without transporting any bills cane realized, paying-in and paying-out transactions can be conducted concurrently with the close examination processing without transporting any bills, and the operation mode can be continued for a long term; the apparatus can be used appropriately for unattended operation. Further, the counting need not be checked during the operation, and close examination processing to interrupt the operation every given time can be omitted. Therefore, the official in charge can be saved from having to manually count the number of rejected sheets, and for the customers, the availability factor of the ATM is raised and serviceability and reliability are enhanced.

If the sheet processing apparatus comprises a plurality of collection boxes being connected to the transport passage for collecting rejected sheets, the plurality of collection boxes can be used properly for various purposes of detaching one collection box for separate collection, etc. If sheets are collected in the collection box as rejected sheets, the total number of sheets can be managed precisely, so that the official in charge can be saved from having to manually count the number of rejected sheets and fully automated counting in the operation mode can be realized.

Further, if one of the plurality of sheet storage sections cane switched to a second collection box, the one sheet storage section can be selected between storage and collection sections for use and can be used properly in response to the storage state and collection state of sheets.

If the number of sheets transported cannot be determined at the transport process, a notification section provides undetermined sheet information, and a determination section acquires the undetermined sheet information provided by the notification section at close examination processing time and determines the closely examined number of sheets in the sheet processing apparatus. In such a configuration, it is known that abnormal media indicated by the undetermined medium information that cannot be recognized as valid sheets are mixed, and the total number of sheets except the abnormal media can be precisely grasped and managed.

If a transaction apparatus comprising such a sheet processing apparatus is adopted, the official in charge can be saved from having to manually count the number of rejected sheets. Therefore, the current balance in the operation mode or at the close examination time can be counted and managed under full automation and automated operation of the transaction apparatus can be still more promoted.

### BRIEF DESCRIPTION OF THE DRAWINGS

FIG. 1 is a drawing to show the internal configuration of a bill processing apparatus contained in an ATM;

FIG. 2 is a schematic view of the main part of a number-of-bills sense unit;

FIG. 3 is a block diagram of a control circuit of the bill processing apparatus;

FIG. 4 is a chart to show the relationship between sensor output voltage of a number-of-bills sense unit and time;

FIG. 5 is a flowchart to show the paying-out processing operation of the bill processing apparatus;

FIG. 6 is a schematic representation of transport to show a paying-out passage of the bill processing apparatus;

FIG. 7 is a flowchart to show the close examination processing operation of the bill processing apparatus;

FIG. 8 is a schematic representation of transport to show a collection continuation state at the paying-out transaction time of the bill processing apparatus;

FIG. 9 is a schematic representation of transport to show a paying-out transport passage of a bill processing apparatus of another embodiment of the invention;

FIG. 10 is a schematic representation of transport to show a paying-out passage of a bill processing apparatus in a related art;

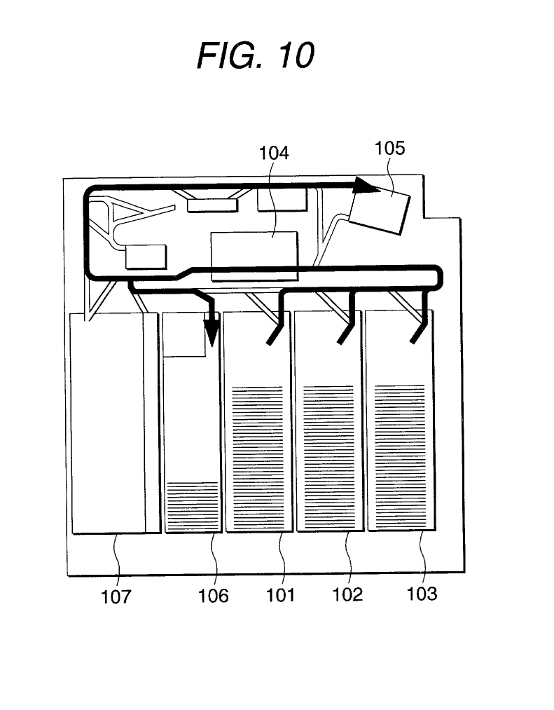

FIG. 11 is a schematic representation of transport to show a close examination passage of the bill processing apparatus in the related art; and

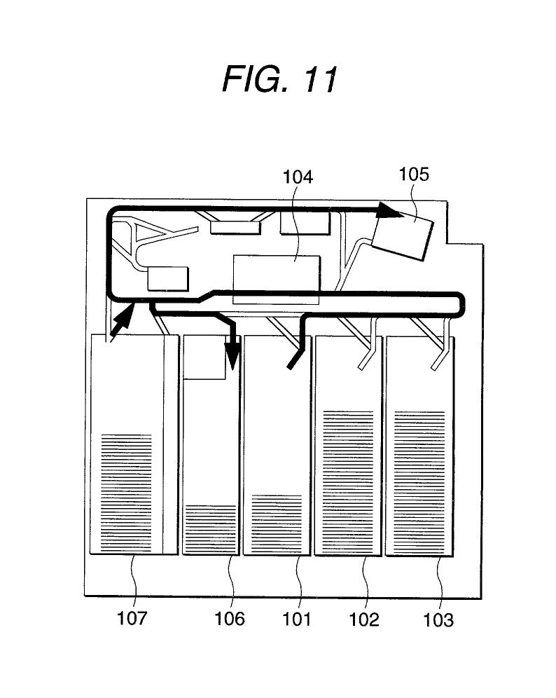

FIG. 12 is a schematic representation to show an operation restart state of the bill processing apparatus in the related art.

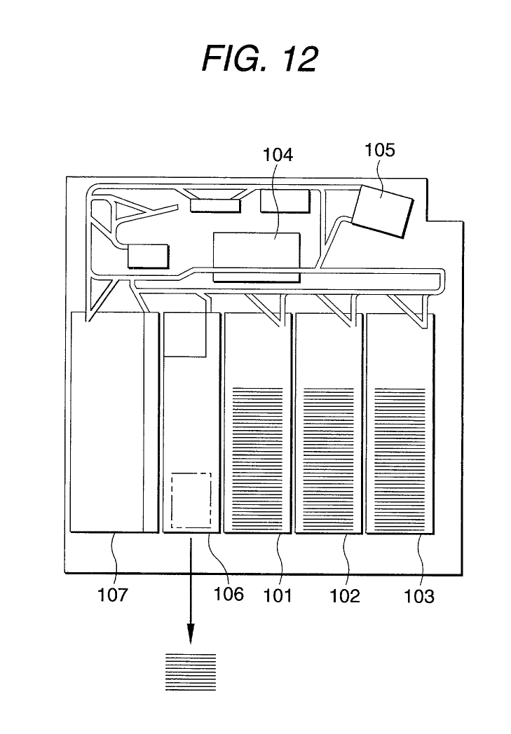

### DETAILED DESCRIPTION OF THE PREFERRED EMBODIMENT

Referring now to the accompanying drawings, there are shown preferred embodiments of the invention.

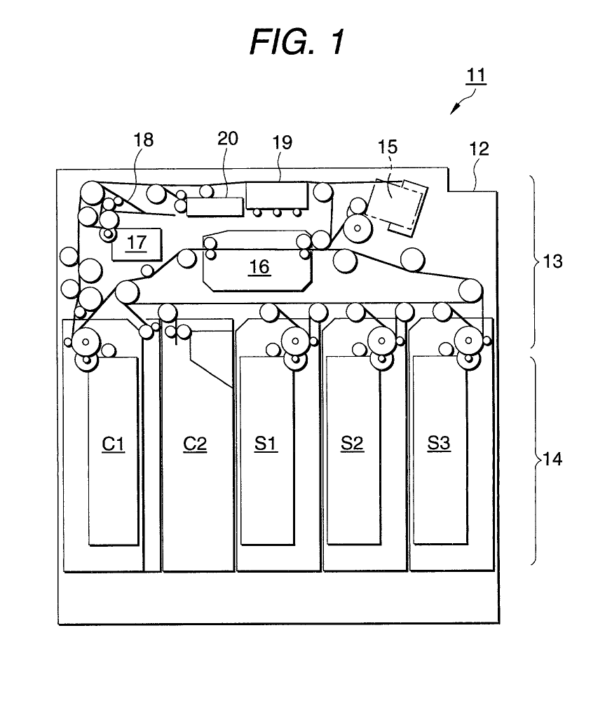

The drawings show a bill processing apparatus contained in an ATM. In FIG. 1, a bill processing apparatus 11 comprises a bill transport group 13 for transporting bills in an upper part of an apparatus main unit 12 and a bill storage group 14 for storing and paying out bills in a lower part, so that the apparatus main unit 12 is separated into the upper part of the transport system and the lower part of the storage system.

The bill transport group 13 in the upper part has a paying-in/paying-out slot 15 in the top of the apparatus main unit 12. Bills inserted into the paying-in/paying-out slot 15 are introduced into a validation section 16 disposed at an upper intermediate position to check for validity, denomination, number of bills, and front or back. Then the bills checked by the validation section 16 are introduced into a temporary hold section 17 for temporarily holding the bills. If the taken-in bill is determined to be in a transport state of the back side, it is introduced into a front and back inversion section 18 and the side of the bill is inverted, then the bill is introduced into the temporary hold section 17. Further, if the bill is determined an identification failure, it is introduced into a return hold section 19 and is temporarily held, then is returned to the former paying-in/paying-out slot 15. At the optimum replenishment timing on operation, the bills S held in the temporary hold section 17 are replenished into the bill storage group 14.

On the other hand, the bill storage group 14 in the lower part comprises first to third stackers S1 to S3 fixedly installed and an operation cartridge C1 and a collection cartridge C2 detachably installed. The first to third stackers S1 to S3 have each a bill accumulation function and a bill paying-out function and store bills of three denominations of 10000 yen, 1000 yen, and 5000 yen by denomination. At the paying-out time, bills are paid out one by one from any of the stackers S1 to S3 and are introduced into the validation section 16 for checking the bills for denomination, then are transported to the paying-in/paying-out slot 15.

The operation cartridge C1 is provided for distributing bills to the stackers S1 to S3 for storage at the opening time or at the bill replenishing time. Further, the operation cartridge C1 is provided for collecting bills from the stackers S1 to 33 at the closing time or when each stacker fills with bills. The collection cartridge C2 is provided for collecting rejected bills such as unidentifiable bills and left bills occurring at the paying-in/paying-out transaction time and at the replenishment processing time. In FIG. 1, numeral 20 denotes a sheet storage section for passage check.

By the way, the apparatus comprises a number-of-bills sense function of precisely counting the number of bills even if bills are transported in an improper state in the transport passage. Accordingly, for example, even if a rejected bill determined to be transported in an overlap state hard to count and to be collected occurs, the total number of bills held in the bill processing apparatus 11 is automatically counted precisely using a number-of-bills sense unit 21 described later.

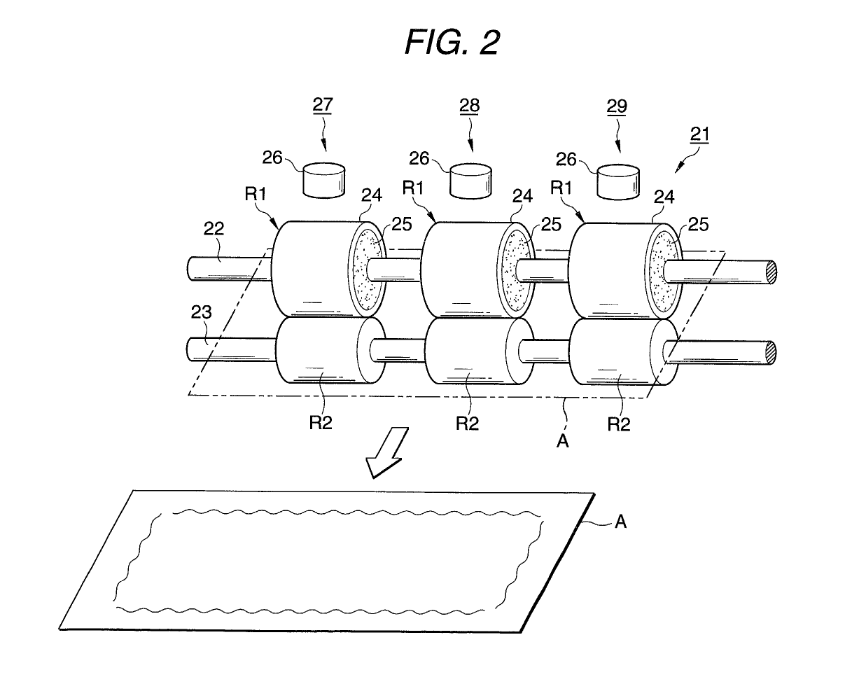

FIG. 2 shows an example of the number-of-bills sense unit 21. This number-of-bills sense unit 21 is disposed on the transport passage of the validation section 16, for example, and comprises an upper roller shaft 22 and a lower roller shaft 23 at up and down positions, Three driven rollers R1 . . . are attached to the upper roller shaft 22 along the axial direction so as to correspond to the center and both end parts of a bill A transported in landscape orientation (short length direction) Each of the driven rollers R1 . . . is made up of a metal pipe 24 of an outer peripheral part and a rubber member 25 sealed between the inner peripheral surface of the metal pipe 24 and the outer peripheral surface of the upper roller shaft 22. The rubber member 25 is bent in response to the thickness of a bill, whereby the corresponding metal pipe 24 is displaced independently of any other metal pipe 24.

On the other hand, three reference rollers R2 . . . are attached to the lower roller shaft 23 so as to face the driven rollers R1 . . . attached to the upper roller shaft 22.

Further, a magnetic coil 26 is placed at a position in the proximity of and above each of the driven rollers R1 . . . The three driven rollers R1 . . . and the three magnetic coils 26 . . . corresponding thereto are paired to make up first to third thickness sensors 27 to 29 for sensing the thicknesses of three points of a bill in the paper transport width direction.

The thickness sensors 27 to 29 separately detect the thickness of a bill A passing through the transport passage; displacement of the driven roller R1 is detected with the corresponding magnetic coil 26 and the mechanical displacement amount is converted into voltage change (electrical quantity) with the coil 26 to provide an electric thickness detection signal.

Therefore, the validity state of each transported bill can be sensed from the thickness sense data of the bill A and in addition, the transported number of the passing-through bills at the time can also be sensed precisely with the bills sorted one by one. Thus, the transported number of bills in an improper transport state of overlap transport, skew transport, etc., and in a bill state having an improper form of fold, break, lack, tape bonding, etc., in addition to a normal transport state of each bill is also counted.

Since the number of passing-through bills A can be thus counted precisely one by one, the total number of bills held in the bill processing apparatus can be counted and managed under full automation. In particular, if a rejected bill to be collected occurs while the bill is transported, it can be counted and checked before it is entered in the collection cartridge C2. Thus, the number of the bills collected in the collection cartridge C2 can be stored in RAM (described later) for precise management without being counted by the official in charge.

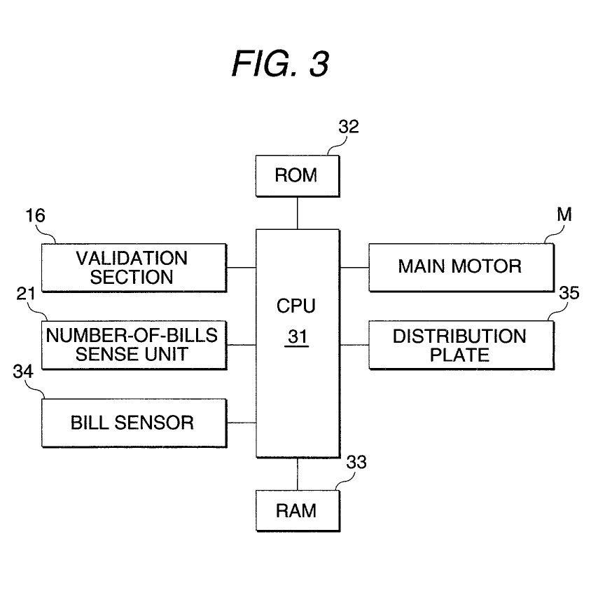

FIG. 3 is a block diagram of a control circuit of the bill processing apparatus 11. A CPU 31 controls components in accordance with a program stored in ROM 32 and stores control data in RAM 33 in a readable mode.

The RAM 33 stores the total number of held bills of not only the bills in a normal transport state sensed by the number-of-bills sense unit 21, but also the rejected bills determined to be improper for transport. Thus, the current balance can be known simply by checking the RAM data.

A main motor M drives the transport passage by a control signal from the CPU 31. A bill sensor 34 senses the transport processing state of each bill transported accordingly. The transported bills are distributed in predetermined directions through a distribution plate 35 disposed at a transport branch position.

The CPU 31 senses the thicknesses of a total of three points of each bill passing through the transport passage by the number-of-bills sense unit 21 and integrally processes the wave form outputs provided by the first to third thickness sensors 27 to 29 at the time for determining the number of the bills passing through the transport passage. When the number of the passing-through bills cannot be determined, information indicating that the number of bills is undefined is output. Further, if image pick-up data of each bill is provided using a CCD image sensor, it can be added for providing still more precise count data.

Next, a method of determining passing-through bills using the first to third thickness sensors 27 to 29 of the number-of-bills sense unit 21 will be discussed.

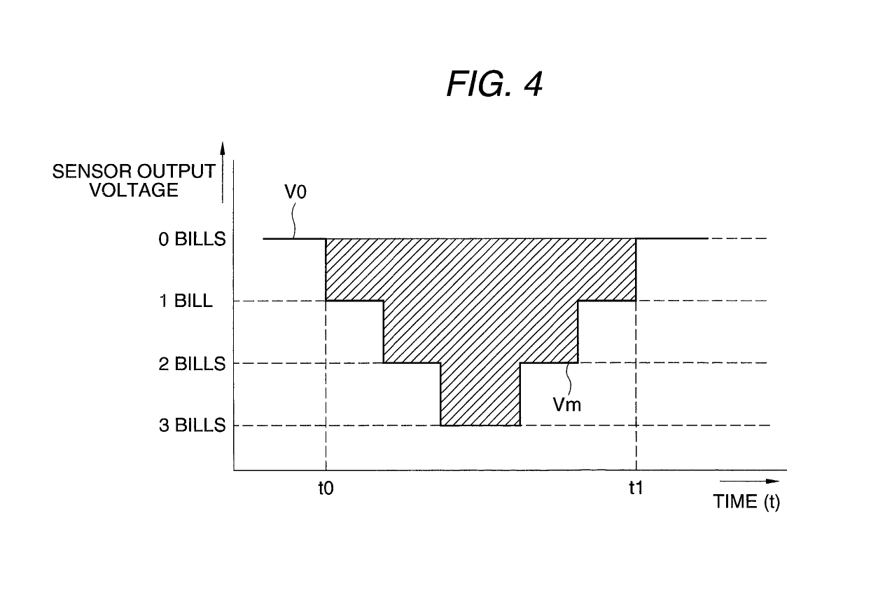

Sensor output voltage Vm (Vo at zero-bill level) of the first to third thickness sensors 27 to 29 is set so that it becomes high when the spacing from the driven roller R1 s “large” and becomes low when the spacing from the driven roller R1 is “small.” Thus, for example, if three cascading bills (which are overlapped and displaced one another) pass through the thickness sensors 27 to 29, the output signal waveform (waveform of voltage change with time) of one thickness sensor is output like steps, as shown in FIG. 4.

When a bill does not arrive, the output voltage Vm is the highest and reaches the voltage value Vo. At time t0 when only the top bill arrives, the output voltage Vm is lessened corresponding to the one bill. When the two cascading bills arrive, the output voltage Vm is more lessened corresponding to the two bills. When the three cascading bills arrive, the output voltage Vm is more lessened corresponding to the three bills.

When the three cascading bills passed through the position of the thickness sensor, the output voltage Vm is restored to the former state Vo at the passage time t1.

In addition, when the transported number of bills cannot be determined at the transport process, the CPU 31 stores undetermined medium information in the R 33 for management. At the close examination processing time, the CPU 31 reads the undetermined medium information stored in the RAM 33 and determines the closely examined number of bills in the apparatus. In doing so, it is known that abnormal media indicated by the undetermined medium information that cannot be recognized as valid bills are mixed, and the total number of bills except the abnormal media can be precisely grasped and managed.

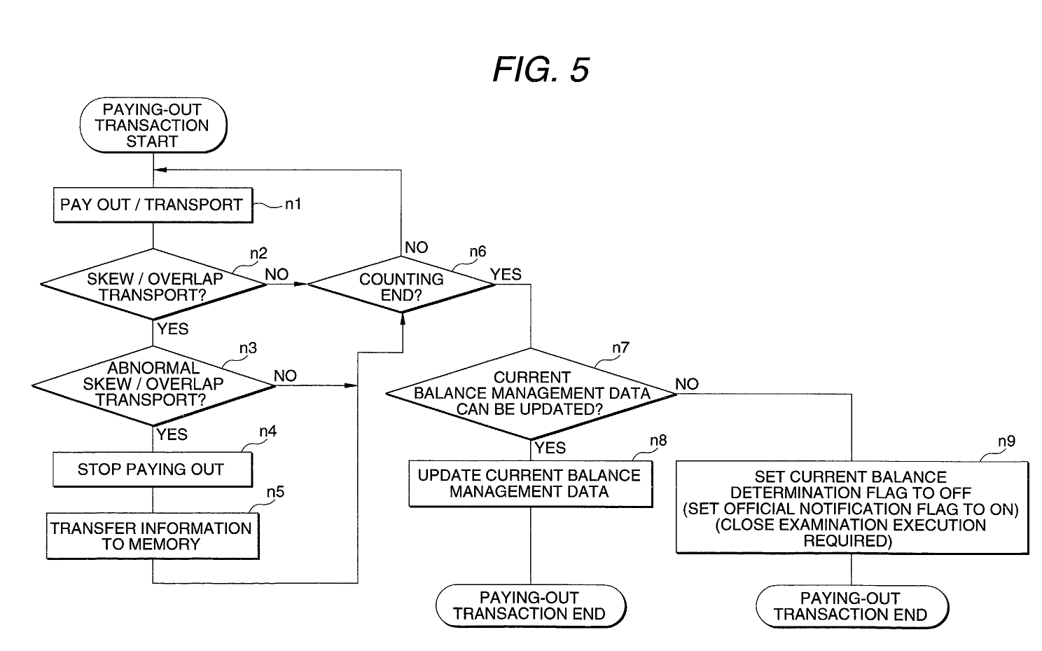

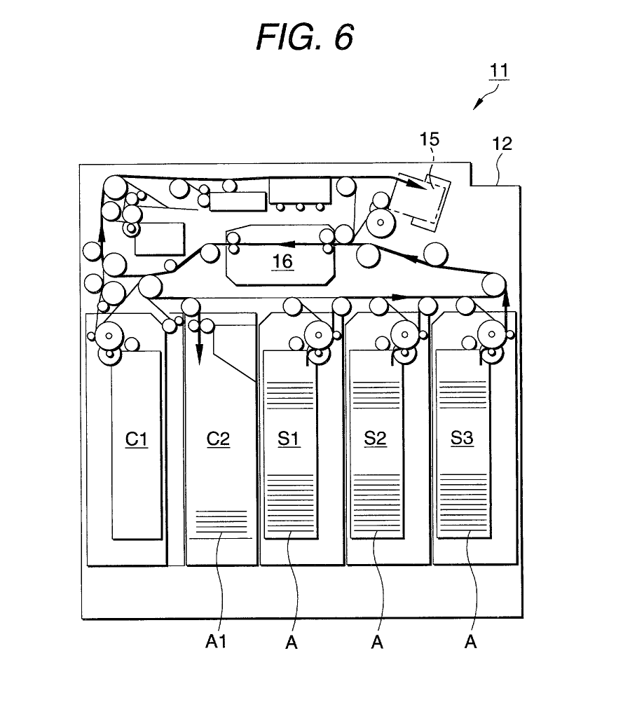

The processing operation when a paying-out transaction is conducted using the described bill processing apparatus 11 will be discussed with reference to a flowchart of FIG. 5 and FIG. 6 showing a paying-out transport passage.

Now, when a paying-out signal is input, the CPU 31 pays out bills A one by one from the specified by-denomination stacker S1 . . . based on paying-out command data, and the paid-out bills A are transported in order through the transport passage to a paying-out processing position (step n1).

At this time, when each bill passes through the position of the number-of-bills sense unit 21, the first to third thickness sensors 27 to 29 sense the thickness distribution state of the bill. From the sense data, whether the passing-through bill is in a proper transport state or an improper transport state of overlap transport, skew transport, etc., is sensed and whether or not the passing-through bill is in a bill state having an improper form of fold, break, lack, tape bonding, etc., is sensed (step n2).

Even if the bills are in an improper transport state or an improper bill state, the number-of-bills sense unit 21 precisely counts the transported number of passing-through bills. At this timer there is a fear of paying out a large number of bills in succession or a large skew and a jam, etc., (step n3), immediately the paying out is stopped. The transported number of the bills paid out so far is stored in the RAM 33 as count data for data management and the paying-out transaction is stopped (steps n4 and n5).

On the other hand, if the bills are transported normally for paying out, the CPU 31 counts the transported number of the bills by the number-of-bills sense unit 21 and the denomination of each bill to be paid out is checked in the validation section 16, then the bills are transported to the paying-in/paying-out slot 15 and are paid out therethrough.

In contrast, if a rejected bill A1 not appropriate for distribution involving fold, break, lack, tape bonding, dirt, etc., exists or if an unidentifiable rejected bill exists and is collected into the collection cartridge C2, the CPU 31 can precisely count the number of the passing-through bills by the number-of-bills sense unit 21 and thus precisely counts and manages the number of bills paid out from the stackers (the number of collected bills added to the normal transported number of bills) (step n6)

Whenever one paying-out transaction is conducted, the CPU 31 updates the current total held amount existing in the bill processing apparatus 11. Therefore, whenever the total number of the held bills changes, the number-of-bills data is updated and the count data is determined (steps n7 and n8).

By the way, when the management data of the current balance cannot be updated, for example, if the official in charge is required because an undetermined medium exists, etc., a current balance determination flag is set to OFF and the official in charge is notified of the fact (step n9).

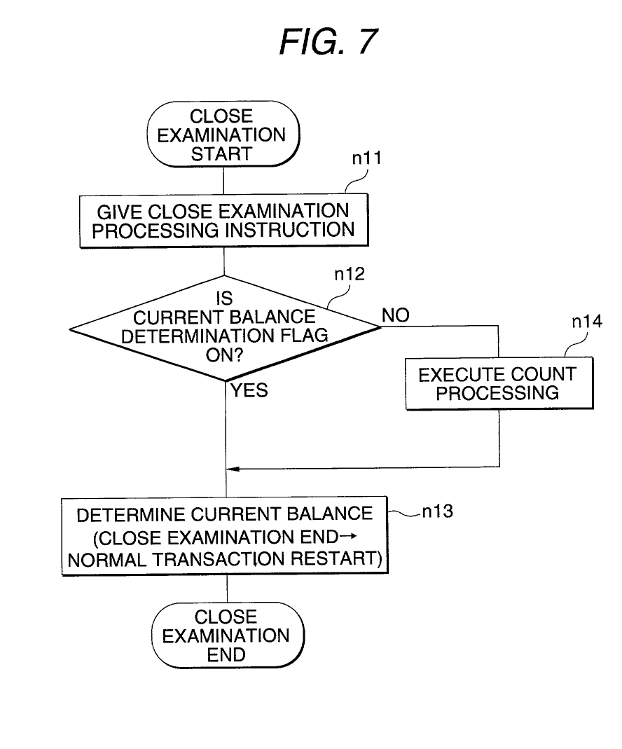

Next, the close examination processing operation of the bill processing apparatus 11 without transporting any bills will be discussed with reference to a flowchart of FIG. 7.

Now, when a close examination signal is input to the CPU 31 (step n11), the CPU 31 reads close examination data stored in the RAM 33 based on the close examination signal. At this time, the CPU 31 reads the numbers of bills stored in the by-denomination stackers S1 to S3 and the number of stored bills collected in the collection cartridge C2 and totalizes the read data of the numbers of stored bills for close examination. Thus, the CPU 31 simply checks the count data stored in the RAM 33, whereby the total number of bills held in the apparatus is precisely determined and the close examination processing is complete simplyby data control. Thus, at the close examination time, bill transporting can be omitted and close examination cane instantaneously conducted without transporting any bills. Therefore, operation of a paying-out transaction, etc., can be continued concurrently with the close examination processing without transporting any bills and the operation mode can be continued for a long term, Therefore, the apparatus can be used appropriately for unattended operation (steps n12 and n13).

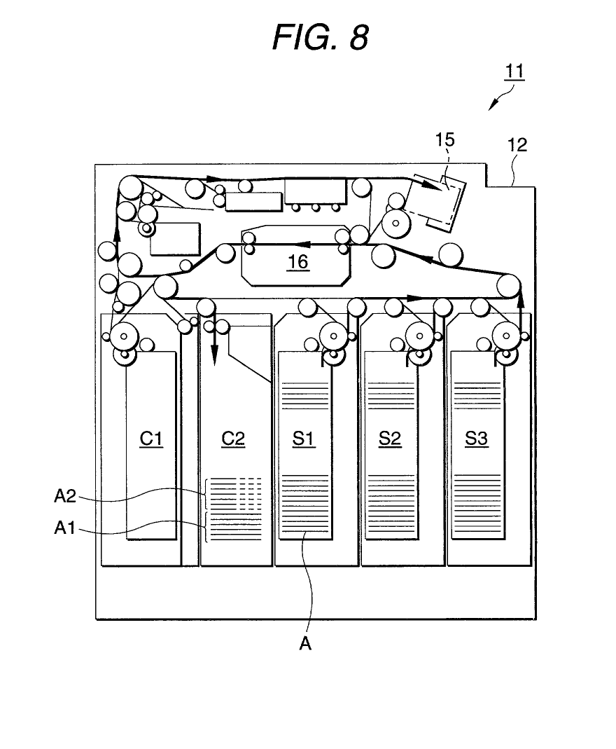

As shown in FIG. 8, when normal transaction such as paying-out transaction is conducted subsequently after the close examination, the transaction can be restarted as the rejected bill A1 collected so far is left in the collection cartridge C2, and if a new rejected bill A2 occurs at the later paying-out transaction time, it is collected. Since the count data can be thus precisely stored and managed in the RAM 33, even if the rejected bills A1 and A2 before and after the close examination are collected in one collection cartridge C2 in a stack state, the number of bills can be clearly counted for management.

On the other hand, if close examination processing involving the official in charge is required because a jam occurs or an undermined medium exists, the official in charge execute recovery work and count work for close examination (step n14).

Such count management is not limited to paying-out processing or close examination processing and is also applied to paying-in processing and replenishment processing; the current balance of the bills stored in the bill processing apparatus 11 is always managed as data under full automation.

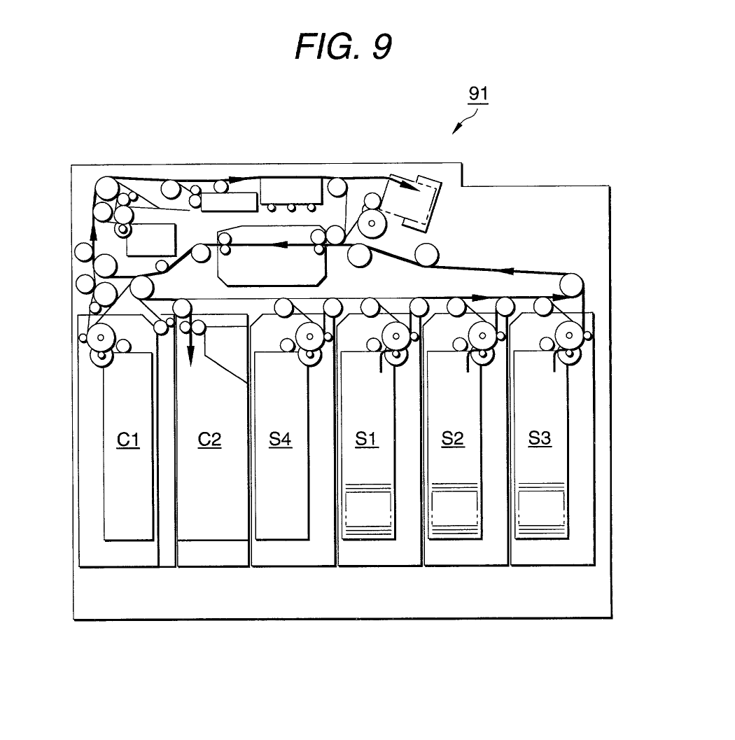

FIG. 9 shows a bill processing apparatus 91 of another embodiment of the invention. This bill processing apparatus 91 is the same as the bill processing apparatus 11 previously described with reference to FIG. 1 except that it comprises four stackers, and therefore only the difference between the bill processing apparatus will be discussed.

A new fourth stacker S4 disposed at the fourth has the same structure as each of first to third stackers S1 to S3 and is disposed in parallel between the first stacker S1 and a collection cartridge C2 for use as either the fourth stacker S4 function or the second collection function. In the normal operation mode of the fourth stacker S4, the fourth stacker S4 is used as a 2000-yen bill storage stacker or an increment stacker and 2000-yen bills can be entered in and taken out from the fourth stacker S4 for paying-in and paying-out transactions.

On the other hand, to switch the fourth stacker S4 to use as the second collection cartridge, rejected bills can be collected in the fourth stacker 54 apart from the original collection cartridge C2.

For example, with a preset operation reference time as a separation, the rejected bills occurring to the reference time and those occurring on and after the reference time can be collected separately so that they can be handled with distinction.

Since the single fourth stacker S4 can be thus selected between storage and collection stackers for use, it can be used properly in response to the current operation state of the storage state and collection state of bills. If the rejected bills are collected separately, the total number of bills can be precisely stored and managed in the REM 33. Thus, if the fourth stacker S4 for the collection function is added, fully automated counting in the operation mode can be realized.

The correspondence between the components of the invention and those of the described-above embodiments is as follows:

The sheet processing apparatus of the invention corresponds to each of the bill processing apparatus 11 and 91 of the embodiments; likewise,

the transaction apparatus corresponds to the ATM,

the sheets correspond to the bill A and the rejected bills A1 and A2;

the sheet storage sections correspond to the first to fourth stackers S1 to S4;

the count section corresponds to the number-of-bills sense unit 21;

the notification section, and the determination section correspond to the CPU 31;

the storage section corresponds to the RAM 33;

the collection box corresponds to the collection cartridge C2; and

the second collection box corresponds to the fourth stacker S4. However, the invention can be applied based on the technical idea as claimed in claims and is not limited to the specific configurations of the embodiments described above.

According to the invention, when sheets are transported, if an improper transport state of overlap transport, skew transport, etc., occurs or an improper sheet of fold, break, etc., is transported, the number of sheets can be counted in the improper state and the total number of sheets held in the sheet processing apparatus can always be precisely counted and managed.

What is claimed is:

1. A sheet processing apparatus comprising:
a plurality of sheet storage sections for storing sheets therein or taking out sheets therefrom via a transport passage;
a count section disposed on the transport passage, for counting the number of sheets transported on the transport passage; and
a storage section for storing a count value provided by said count section.

2. The sheet processing apparatus as claimed in claim 1, comprising:
a first collection section connected to the transport passage.

3. The sheet processing apparatus as claimed in claim 1, wherein one of said plurality of sheet storage sections can be switched to a second collection section.

4. The sheet processing apparatus as claimed in claim 1, further comprising:
a notification section, when the number of sheets transported on the transport passage cannot be determined, for providing undetermined sheet information; and
a determination section for determining the number of sheets in said sheet processing apparatus on the basis of the undetermined sheet information provided by the notification section at close examination processing.

5. The sheet processing apparatus as claimed in claim 1, wherein said count section includes:
a plurality of thickness detection units, which are separately disposed on the transport passage, for respectively detecting thicknesses of predetermined parts of the sheet passing through the transport passage; and
a control unit for determining the number of sheets on the basis of the thicknesses of sheet provided by the thickness detection units.

6. The sheet processing apparatus as claimed in claim 1, further comprising:
a determination section for reading out the count value from said storage section at close examination processing, and determining the number of sheets in said sheet processing apparatus.

7. The sheet processing apparatus as claimed in claim 5, further comprising:
a determination section for reading out the count value from said storage section at close examination processing, and determining the number of sheets in said sheet processing apparatus.

8. A transaction apparatus comprising:
a paying-out/paying-in section for paying-out or paying-in sheets therefrom;
a plurality of sheet storage sections for storing sheets therein or taking out sheets therefrom via a transport passage for paying-in or paying-out the sheets;
a count section disposed on the transport passage, for counting the number of sheets transported on the transport passage; and
a storage section for storing a count value provided by said count section.

9. The transaction apparatus as claimed in claim 8, wherein said count section includes:
a plurality of thickness detection units, which are separately disposed on the transport passager for respectively detecting thicknesses of predetermined parts of the sheet passing through the transport passage; and
a control unit for determining the number of sheets on the basis of the thicknesses of sheet provided by the thickness detection units.

10. The sheet processing apparatus as claimed in claim 9, further comprising;
a determination section for reading out the count value from said storage section at close examination processing, and determining the number of sheets in said sheet processing apparatus.

11. A method for close examining sheets in a sheet processing apparatus comprising:
storing sheets into a plurality of sheet storage sections or taking out the sheets from the plurality of sheet storage sections via a transport passage;
counting the number of sheets transported on the transport passage;
storing a count value provided by said count step in a storage section; and
reading out the count value from the storage section at close examination processing, and determining the number of sheets in the sheet processing apparatus.

12. The method for close examining sheets in the sheet processing apparatus as claimed in claim 11, further comprising:
detecting thicknesses of predetermined parts of the sheet passing through the transport passage; and
determining the number of sheets passing through the transport passage on the basis of the thicknesses of the sheet provided by said detecting step.
